(19) United States
(12) Patent Application Publication
(10) Pub. No.: US 2016/0259075 A1
(43) Pub. Date: Sep. 8, 2016

(54) ACQUISITION FOOTPRINT ATTENUATION IN SEISMIC DATA

(71) Applicant: WesternGeco, LLC, Houston, TX (US)

(72) Inventors: Chirag Tyagi, Gatwick (GB); Ian Scott, Gatwick (GB)

(21) Appl. No.: 15/014,714

(22) Filed: Feb. 3, 2016

Related U.S. Application Data
(60) Provisional application No. 62/111,925, filed on Feb. 4, 2015.

(51) Int. Cl. G01V 1/36; G01V 1/30

(52) U.S. Cl. CPC G01V 1/364; G01V 1/302

(57) ABSTRACT

Various implementations directed to acquisition footprint attenuation in seismic data are provided. In one implementation, a method may include receiving seismic data that had been acquired using a seismic survey of a region of interest. The method may also include decomposing the received seismic data into a plurality of components based on a spatial coherency of the plurality of components. The method may further include identifying components of the plurality of components having acquisition footprints. The method may additionally include transforming the components having the acquisition footprints to a time-slice domain. The method may also include separating the acquisition footprints from the seismic data within the transformed components. The method may further include generating a seismic volume corresponding to the region of interest, where the acquisition footprints within the seismic volume are attenuated based on the separation.

### CROSS-REFERENCE TO RELATED APPLICATIONS

This application claims benefit of U.S. provisional patent application Ser. No. 62/111,925, filed Feb. 4, 2015 and titled METHOD FOR COMPENSATION FOR AMPLITUDE STRIPES, the entire disclosure of which is herein incorporated by reference.

### BACKGROUND

Seismic exploration may involve surveying subterranean geological formations for hydrocarbon deposits in a region of interest. A seismic survey may involve deploying survey equipment, such as seismic source(s) and seismic sensors, at predetermined locations. The sources may generate seismic waves, which propagate into the geological formations, creating pressure changes and vibrations along their way. Changes in elastic properties of the geological formation may scatter the seismic waves, changing their direction of propagation and other properties. Part of the energy emitted by the sources may reach the seismic sensors. Some seismic sensors may be sensitive to pressure changes (hydrophones), others to particle motion (e.g., geophones), and industrial surveys may deploy one type of sensors or both. In response to the detected seismic events, the sensors may generate electrical signals to produce seismic data. Analysis of the seismic data can then indicate the presence or absence of probable locations of hydrocarbon deposits.

In one scenario, the seismic data may be three-dimensional (3D), and may be organized in the form of a seismic volume corresponding to the region of interest, such as in the form of a 3D seismic cube. Such a seismic volume may be used to provide more detailed structural and stratigraphic images of the subterranean geological formations. However, one or more acquisition footprints may be present in the seismic volume. These acquisition footprints may interfere with the interpretation of the stratigraphic images of the seismic volume.

### SUMMARY

Described herein are implementations of various technologies and techniques for acquisition footprint attenuation in seismic data. In one implementation, a method may include receiving seismic data that had been acquired using a seismic survey of a region of interest. The method may also include decomposing the received seismic data into a plurality of components based on a spatial coherency of the plurality of components. The method may further include identifying one or more components of the plurality of components having one or more acquisition footprints. The method may additionally include transforming the one or more components having the one or more acquisition footprints to a time-slice domain. The method may also include separating the one or more acquisition footprints from the seismic data within the one or more transformed components. The method may further include generating a seismic volume corresponding to the region of interest, where the one or more acquisition footprints within the seismic volume are attenuated based on the separation.

In another implementation, a non-transitory computer-readable medium having stored thereon a plurality of computer-executable instructions which, when executed by a computer, cause the computer to receive seismic data acquired using a seismic survey of a region of interest. The computer-executable instructions may also cause the computer to decompose the received seismic data into a plurality of components based on a spatial coherency of the plurality of components. The computer-executable instructions may further cause the computer to identify one or more components of the plurality of components having one or more acquisition footprints. The computer-executable instructions may additionally cause the computer to transform the one or more components having the one or more acquisition footprints to a time-slice domain. The computer-executable instructions may also cause the computer to separate the one or more acquisition footprints from the seismic data within the one or more transformed components. The computer-executable instructions may further cause the computer to generate a seismic volume corresponding to the region of interest, where the one or more acquisition footprints within the seismic volume are attenuated based on the separation.

In yet another implementation, a computer system may include a processor and a memory, the memory having a plurality of program instructions which, when executed by the processor, cause the processor to receive seismic data acquired using a seismic survey of a region of interest. The plurality of program instructions may also cause the processor to decompose the received seismic data into a plurality of components based on a spatial coherency of the plurality of components. The plurality of program instructions may further cause the processor to identify one or more components of the plurality of components having one or more acquisition footprints. The plurality of program instructions may additionally cause the processor to transform the one or more components having the one or more acquisition footprints to a time-slice domain. The plurality of program instructions may also cause the processor to separate the one or more acquisition footprints from the seismic data within the one or more transformed components. The plurality of program instructions may further cause the processor to generate a seismic volume corresponding to the region of interest, where the one or more acquisition footprints within the seismic volume are attenuated based on the separation.

The above referenced summary section is provided to introduce a selection of concepts in a simplified form that are further described below in the detailed description section. The summary is not intended to be used to limit the scope of the claimed subject matter. Furthermore, the claimed subject matter is not limited to implementations that solve any disadvantages noted in any part of this disclosure. Indeed, the systems, methods, processing procedures, techniques, and workflows disclosed herein may complement or replace conventional methods for identifying, isolating, and/or processing various aspects of seismic signals or other data that is collected from a subsurface region or other multi-dimensional space, including time-lapse seismic data collected in a plurality of surveys.

### BRIEF DESCRIPTION OF THE DRAWINGS

Implementations of various techniques will hereafter be described with reference to the accompanying drawings. It should be understood, however, that the accompanying drawings illustrate the various implementations described herein and are not meant to limit the scope of various techniques described herein.

FIGS. 1.1-1.4 illustrate simplified, schematic views of an oilfield having subterranean formation containing reservoir therein in accordance with implementations of various technologies and techniques described herein.

FIG. 2 illustrates a schematic view, partially in cross section of an oilfield having data acquisition tools positioned at various locations along the oilfield for collecting data of a subterranean formation in accordance with implementations of various technologies and techniques described herein.

FIG. 3 illustrates an oilfield for performing production operations in accordance with implementations of various technologies and techniques described herein.

FIG. 4 illustrates a seismic system in accordance with implementations of various technologies and techniques described herein.

FIG. 5 illustrates a schematic diagram of a marine-based seismic acquisition system for use in a seismic survey in accordance with implementations of various techniques described herein.

FIG. 6 illustrates a flow diagram of a method for determining a fracture type of one or more fractures in a region of interest in accordance with implementations of various techniques described herein.

FIG. 7 illustrates a diagram of a three-dimensional (3D) seismic cube for the region of interest in accordance with implementations of various techniques described herein.

FIG. 8 illustrates a diagram of a 3D cube, where the cube is formed from the summed components which correspond to the acquisition footprints, in accordance with implementations of various techniques described herein.

FIG. 9 illustrates a diagram of a transformed 3D cube in accordance with implementations of various techniques described herein.

FIG. 10 illustrates a diagram of a transformed 3D cube after one or more first filtering techniques have been applied in accordance with implementations of various techniques described herein.

FIG. 11 illustrates a diagram of a retransformed 3D cube in accordance with implementations of various techniques described herein.

FIG. 12 illustrates a schematic diagram of a computing system in which the various technologies described herein may be incorporated and practiced.

### DETAILED DESCRIPTION

The discussion below is directed to certain specific implementations. It is to be understood that the discussion below is for the purpose of enabling a person with ordinary skill in the art to make and use any subject matter defined now or later by the patent “claims” found in any issued patent herein.

It is specifically intended that the claims not be limited to the implementations and illustrations contained herein, but include modified forms of those implementations including portions of the implementations and combinations of elements of different implementations as come within the scope of the following claims.

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to obscure aspects of the embodiments.

It will also be understood that, although the terms first, second, etc. may be used herein to describe various elements, these elements should not be limited by these terms. These terms are used to distinguish one element from another. For example, a first object could be termed a second object, and, similarly, a second object could be termed a first object, without departing from the scope of the claims. The first object and the second object are both objects, respectively, but they are not to be considered the same object.

The terminology used in the description of the present disclosure herein is for the purpose of describing particular implementations and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses one or more possible combinations of one or more of the associated listed items. It will be further understood that the terms “includes” and/or “including,” when used in this specification, specify the presence of stated features, integers, operations, elements, and/or components, but do not preclude the presence or addition of one or more other features, integers, operations, elements, components and/or groups thereof.

As used herein, the terms “up” and “down”; “upper” and “lower”; “upwardly” and downwardly”; “below” and “above”; and other similar terms indicating relative positions above or below a given point or element may be used in connection with some implementations of various technologies described herein. However, when applied to equipment and methods for use in wells that are deviated or horizontal, or when applied to equipment and methods that when arranged in a well are in a deviated or horizontal orientation, such terms may refer to a left to right, right to left, or other relationships as appropriate.

It should also be noted that in the development of any such actual implementation, numerous decisions specific to circumstance may be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The terminology and phraseology used herein is solely used for descriptive purposes and should not be construed as limiting in scope. Language such as “having,” “containing,” or “involving,” and variations thereof, is intended to be broad and encompass the subject matter listed thereafter, equivalents, and additional subject matter not recited.

Furthermore, the description and examples are presented solely for the purpose of illustrating the different embodiments, and should not be construed as a limitation to the scope and applicability. While any composition or structure may be described herein as having certain materials, it should be understood that the composition could optionally include two or more different materials. In addition, the composition or structure may also include some components other than the ones already cited. It should also be understood that throughout this specification, when a range is described as being useful, or suitable, or the like, it is intended that any value within the range, including the end points, is to be considered as having been stated. Furthermore, respective numerical values should be read once as modified by the term “about” (unless already expressly so modified) and then read again as not to be so modified unless otherwise stated in context. For example, “a range of from 1 to 10” is to be read as indicating a respective possible number along the continuum between about 1 and about 10. In other words, when a certain range is expressed, even if a few specific data points are explicitly identified or referred to within the range, or even when no data points are referred to within the range, it is to be understood that the inventors appreciate and understand that any data points within the range are to be considered to have been specified, and that the inventors have possession of the entire range and points within the range.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

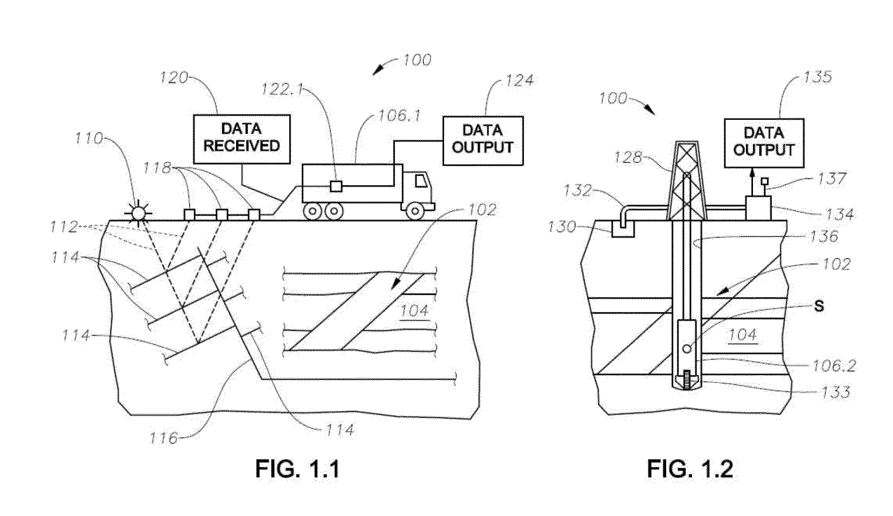

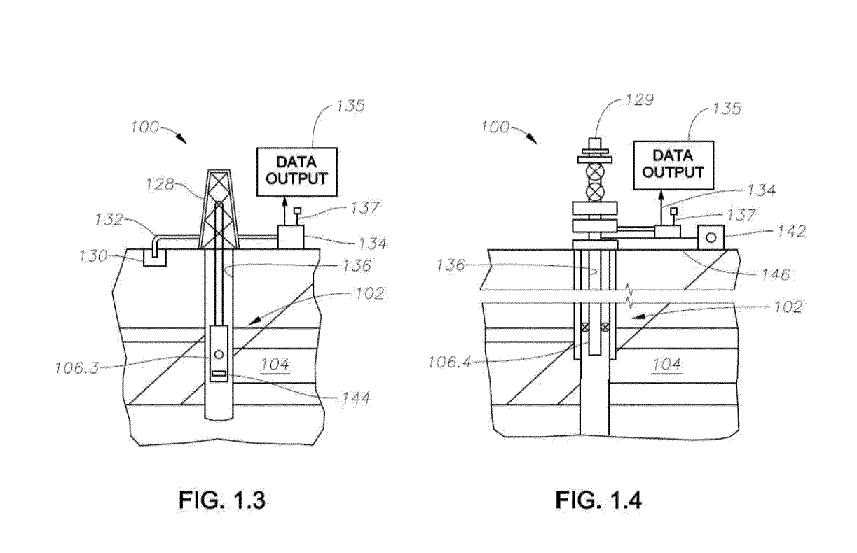

One or more implementations of various techniques for acquisition footprint attenuation in seismic data will now be described in more detail with reference to FIGS. 1-12 in the following paragraphs.

### Production Environment & Seismic Acquisition

Seismic exploration may involve surveying subterranean geological formations for hydrocarbon deposits. A seismic survey may involve deploying seismic equipment, such as seismic source(s) and seismic sensors, at predetermined locations in one or more various configurations, as further explained below.

FIGS. 1.1-1.4 illustrate simplified, schematic views of a production field 100 having a subterranean formation 102 containing reservoir 104 therein in accordance with implementations of various technologies and techniques described herein. The production field 100 may be an oilfield, a gas field, and/or the like. FIG. 1.1 illustrates a survey operation being performed by a survey tool, such as seismic truck 106.1, to measure properties of the subterranean formation 102. The survey operation may be a seismic survey operation for producing sound vibrations. In FIG. 1.1, one such sound vibration, e.g., sound vibration 112 generated by source 110, may reflect off horizons 114 in earth formation 116. A set of sound vibrations may be received by sensors, such as geophone-receivers 118, situated on the earth's surface. The data received 120 may be provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1.2 illustrates a drilling operation being performed by drilling tools 106.2 suspended by rig 128 and advanced into subterranean formations 102 to form wellbore 136. Mud pit 130 may be used to draw drilling mud into the drilling tools via flow line 132 for circulating drilling mud down through the drilling tools, then up wellbore 136 and back to the surface. The drilling mud may be filtered and returned to the mud pit. A circulating system may be used for storing, controlling, or filtering the flowing drilling mud. The drilling tools may be advanced into subterranean formations 102 to reach reservoir 104. Each well may target one or more reservoirs. The drilling tools may be adapted for measuring downhole properties using logging while drilling tools. The logging while drilling tools may also be adapted for taking core sample 133 as shown.

Computer facilities may be positioned at various locations about the production field 100 (e.g., the surface unit 134) and/or at remote locations. Surface unit 134 may be used to communicate with the drilling tools and/or offsite operations, as well as with other surface or downhole sensors. Surface unit 134 may be capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about production field 100 to collect data relating to various production field operations as described previously. As shown, sensor (S) may be positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly may include capabilities for measuring, processing, and storing information, as well as communicating with surface unit 134. The bottom hole assembly may further include drill collars for performing various other measurement functions.

The bottom hole assembly may include a communication subassembly that communicates with surface unit 134. The communication subassembly may be adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It may be appreciated by one of skill in the art that a variety of telemetry systems may be employed, such as wired drill pipe, electromagnetic or other known telemetry systems.

The wellbore may be drilled according to a drilling plan that is established prior to drilling. The drilling plan may set forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the production field 100 or other locations. Surface unit 134 may also be provided with or functionally connected to one or more controllers (not shown) for actuating mechanisms at production field 100. Surface unit 134 may then send command signals to production field 100 in response to data received. Surface unit 134 may receive commands via transceiver 137 or may itself execute commands to the controller. A processor may be provided to analyze the data (locally or remotely), make the decisions and/or actuate the controller. In this manner, production field 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 1.3 illustrates a wireline operation being performed by wireline tool 106.3 suspended by rig 128 and into wellbore 136 of FIG. 1.2. Wireline tool 106.3 may be adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1.1. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about production field 100 to collect data relating to various field operations as described previously. As shown, sensor S may be positioned in wireline tool 106.3 to measure downhole parameters which relate to, for example porosity, permeability, fluid composition and/or other parameters of the field operation.

FIG. 1.4 illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about production field 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1.2-1.4 illustrate tools used to measure properties of a production field, such as an oilfield or gas field, it may be appreciated that the tools may be used in connection with other operations, such as mines, aquifers, storage, or other subterranean facilities. Also, while certain data acquisition tools are depicted, it may be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1.1-1.4 may be an example of a field usable with oilfield or gas field application frameworks. At least part of the production field 100 may be on land, water, and/or sea. Also, while a single field measured at a single location may be depicted, oilfield or gas field applications may be utilized with any combination of one or more oilfields and/or gas field, one or more processing facilities and one or more wellsites.

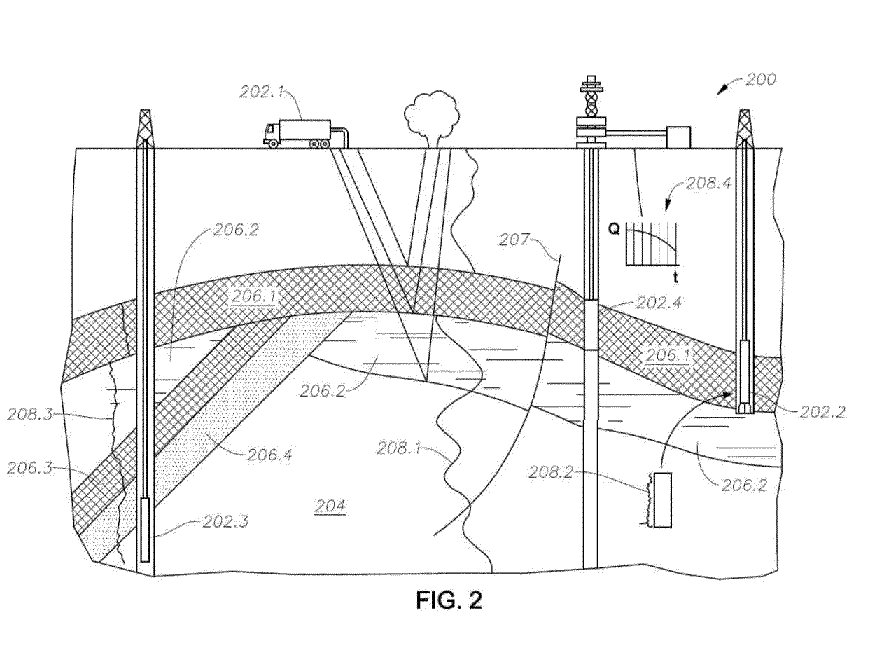

FIG. 2 illustrates a schematic view, partially in cross section of production field 200 having data acquisition tools 202.1, 202.2, 202.3 and 202.4 positioned at various locations along production field 200 for collecting data of subterranean formation 204 in accordance with implementations of various technologies and techniques described herein. The production field 200 may be an oilfield, a gas field, and/or the like. Data acquisition tools 202.1-202.4 may be the same as data acquisition tools 106.1-106.4 of FIGS. 1.1-1.4, respectively, or others not depicted. As shown, data acquisition tools 202.1-202.4 may generate data plots or measurements 208.1-208.4, respectively. These data plots may be depicted along production field 200 to demonstrate the data generated by the various operations.

Data plots 208.1-208.3 may be examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 may be a seismic two-way response over a period of time. Static plot 208.2 may be core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 may be a logging trace that may provide a resistivity or other measurement of the formation at various depths.

A production decline curve or graph 208.4 may be a dynamic data plot of the fluid flow rate over time. The production decline curve may provide the production rate as a function of time. As the fluid flows through the wellbore, measurements may be taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 may have a plurality of geological formations 206.1-206.4. As shown, this structure may have several formations or layers, including a shale layer 206.1, a carbonate layer 206.2, a shale layer 206.3 and a sand layer 206.4. A fault 207 may extend through the shale layer 206.1 and the carbonate layer 206.2. The static data acquisition tools may be adapted to take measurements and detect characteristics of the formations.

While a specific subterranean formation with specific geological structures is depicted, it may be appreciated that production field 200 may contain a variety of geological structures and/or formations, sometimes having extreme complexity. In some locations, such as below the water line, fluid may occupy pore spaces of the formations. Each of the measurement devices may be used to measure properties of the formations and/or its geological features. While each acquisition tool may be shown as being in specific locations in production field 200, it may be appreciated that one or more types of measurement may be taken at one or more locations across one or more fields or other locations for comparison and/or analysis.

The data collected from various sources, such as the data acquisition tools of FIG. 2, may then be processed and/or evaluated. The seismic data displayed in static data plot 208.1 from data acquisition tool 202.1 may be used by a geophysicist to determine characteristics of the subterranean formations and features. The core data shown in static plot 208.2 and/or log data from well log 208.3 may be used by a geologist to determine various characteristics of the subterranean formation. The production data from graph 208.4 may be used by the reservoir engineer to determine fluid flow reservoir characteristics. The data analyzed by the geologist, geophysicist and the reservoir engineer may be analyzed using modeling techniques.

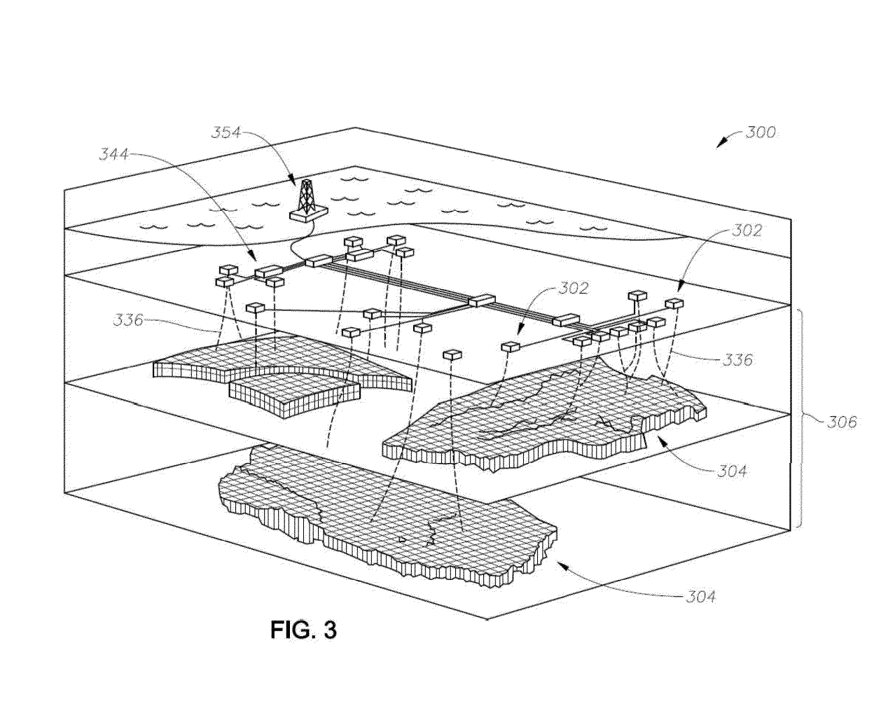

FIG. 3 illustrates a production field 300 for performing production operations in accordance with implementations of various technologies and techniques described herein. The production field 300 may be an oilfield, a gas field, and/or the like. As shown, the production field 300 may have a plurality of wellsites 302 operatively connected to central processing facility 354. The production field configuration of FIG. 3 may not be intended to limit the scope of the production field application system. At least part of the production field may be on land and/or sea. Also, while a single production field with a single processing facility and a plurality of wellsites is depicted, any combination of one or more production fields, one or more processing facilities and one or more wellsites may be present.

Each wellsite 302 may have equipment that forms wellbore 336 into the earth. The wellbores may extend through subterranean formations 306 including reservoirs 304. These reservoirs 304 may contain fluids, such as hydrocarbons. The wellsites may draw fluid from the reservoirs and pass them to the processing facilities via surface networks 344. The surface networks 344 may have tubing and control mechanisms for controlling the flow of fluids from the wellsite to processing facility 354.

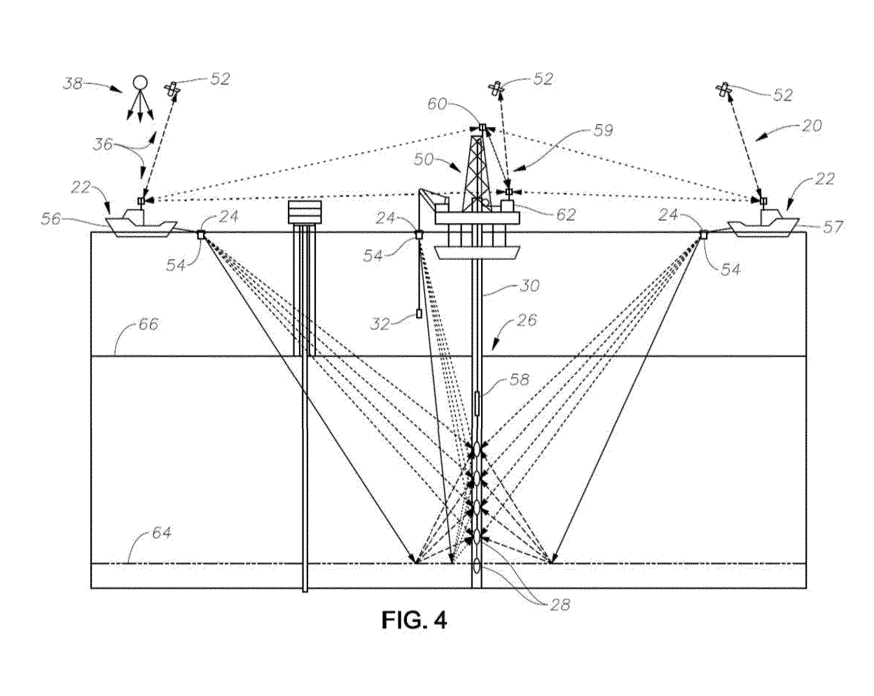

FIG. 4 illustrates a seismic system 20 in accordance with implementations of various technologies and techniques described herein. The seismic system 20 may include a plurality of tow vessels 22 that are employed to enable seismic profiling, e.g. three-dimensional vertical seismic profiling or rig/offset vertical seismic profiling. In FIG. 4, a marine system may include a rig 50, a plurality of vessels 22, and one or more acoustic receivers 28. Although a marine system is illustrated, other implementations of the disclosure may not be limited to this example. A person of ordinary skill in the art may recognize that land or offshore systems may be used.

Although two vessels 22 are illustrated in FIG. 4, a single vessel 22 with multiple source arrays 24 or multiple vessels 22 with single or multiple sources 24 may be used. In some implementations, at least one source and/or source array 24 may be located on the rig 50, as shown by the rig source in FIG. 4. As the vessels 22 travel on predetermined or systematic paths, their locations may be recorded through the use of navigation system 36. In some implementations, the navigation system 36 may utilize a global positioning system (GPS) 38 to record the position, speed, direction, and other parameters of the tow vessels 22.

As shown, the global positioning system 38 may utilize or work in cooperation with satellites 52 which operate on a suitable communication protocol, e.g. VSAT communications. The VSAT communications may be used, among other things, to supplement VHF and UHF communications. The GPS information can be independent of the VSAT communications and may be input to a processing system or other suitable processors to predict the future movement and position of the vessels 22 based on real-time information. In addition to predicting future movements, the processing system also can be utilized to provide directions and coordinates as well as to determine initial shot times, as described above. A control system effectively utilizes the processing system in cooperation with a source controller and a synchronization unit to synchronize the sources 24 with the downhole data acquisition system 26.

As shown, the one or more vessels 22 may respectively tow one or more acoustic sources/source arrays 24. The source arrays 24 include one or more seismic signal generators 54, e.g. air guns, configured to create a seismic and/or sonic disturbance. In the implementation illustrated, the tow vessels 22 comprise a master source vessel 56 (Vessel A) and a slave source vessel 57 (Vessel B). However, other numbers and arrangements of tow vessels 22 may be employed to accommodate the parameters of a given seismic profiling application. For example, one source 24 may be mounted at rig 50 (see FIG. 4) or at another suitable location, and both vessels 22 may serve as slave vessels with respect to the rig source 24 or with respect to a source at another location.

However, a variety of source arrangements and implementations may be used. When utilizing dithered timing between the sources, for example, the master and slave locations of the sources can be adjusted according to the parameters of the specific seismic profiling application. In some implementations, one of the source vessels 22 (e.g. source vessel A in FIG. 4) may serve as the master source vessel while the other source vessel 22 serves as the slave source vessel with dithered firing. However, an alternate source vessel 22 (e.g. source vessel B in FIG. 4) may serve as the master source vessel while the other source vessel 22 serves as the slave source vessel with dithered firing.

Similarly, the rig source 22 may serve as the master source while one of the source vessels 22 (e.g. vessel A) serves as the slave source vessel with dithered firing. The rig source 22 also may serve as the master source while the other source vessel 22 (e.g. vessel B) serves as the slave source vessel with dithered firing. In some implementations, the rig source 22 may serve as the master source while both of the source vessels 22 serve as slave source vessels each with dithered firings. These and other implementations may be used in achieving the desired synchronization of sources 22 with the downhole acquisition system 26.

The acoustic receivers 28 of data acquisition system 26 may be deployed in borehole 30 via a variety of delivery systems, such as wireline delivery systems, slickline delivery systems, and other suitable delivery systems. Although a single acoustic receiver 28 could be used in the borehole 30, a plurality of receivers 28, as shown, may be located in a variety of positions and orientations. The acoustic receivers 28 may be configured for sonic and/or seismic reception. Additionally, the acoustic receivers 28 may be communicatively coupled with processing equipment 58 located downhole. In one implementation, processing equipment 58 may comprise a telemetry system for transmitting data from acoustic receivers 28 to additional processing equipment 59 located at the surface, e.g. on the rig 50 and/or vessels 22.

Depending on the data communication system, surface processing equipment 59 may include a radio repeater 60, an acquisition and logging unit 62, and a variety of other and/or additional signal transfer components and signal processing components. The radio repeater 60 along with other components of processing equipment 59 may be used to communicate signals, e.g. UHF and/or VHF signals, between vessels 22 and rig 50 and to enable further communication with downhole data acquisition system 26.

It should be noted the UHF and VHF signals can be used to supplement each other. The UHF band may support a higher data rate throughput, but can be susceptible to obstructions and has less range. The VHF band may be less susceptible to obstructions and may have increased radio range but its data rate throughput is lower. In FIG. 4, the VHF communications may “punch through” an obstruction in the form of a production platform.

In some implementations, the acoustic receivers 28 may be coupled to surface processing equipment 59 via a hardwired connection. In other implementations, wireless or optical connections may be employed. In still other implementations, combinations of coupling techniques may be employed to relay information received downhole via the acoustic receivers 28 to an operator and/or the control system described above, located at least in part at the surface.

In addition to providing raw or processed data uphole to the surface, the coupling system, e.g. downhole processing equipment 58 and surface processing equipment 59, may be designed to transmit data or instructions downhole to the acoustic receivers 28. For example, the surface processing equipment 59 may comprise a synchronization unit, which may coordinate the firing of sources 24, e.g. dithered (delayed) source arrays, with the acoustic receivers 28 located in borehole 30. In one implementation, the synchronization unit may use a coordinated universal time to ensure accurate timing. In some implementations, the coordinated universal time system may be employed in cooperation with global positioning system 38 to obtain UTC data from the GPS receivers of GPS system 38.

FIG. 4 illustrates one example of a system for performing seismic profiling that can employ simultaneous or near-simultaneous acquisition of seismic data. In one implementation, the seismic profiling may comprise three-dimensional vertical seismic profiling, but other applications may utilize rig and/or offset vertical seismic profiling or seismic profiling employing walkaway lines. An offset source can be provided by a source 24 located on rig 50, on a vessel 22, and/or on another vessel or structure. In one implementation, the vessels 22 may be substantially stationary.

In one implementation, the overall seismic system 20 may employ various arrangements of sources 24 on vessels 22 and/or rig 50 with each location having at least one source and/or source array 24 to generate acoustic source signals. The acoustic receivers 28 of downhole acquisition system 26 may be configured to receive the source signals, at least some of which are reflected off a reflection boundary 64 located beneath a sea bottom 66. The acoustic receivers 28 may generate data streams that are relayed uphole to a suitable processing system, e.g. the processing system described above, via downhole telemetry/processing equipment 58.

While the acoustic receivers 28 generate data streams, the navigation system 36 may determine a real-time speed, position, and direction of each vessel 22 and may estimate initial shot times accomplished via signal generators 54 of the appropriate source arrays 24. The source controller may be part of surface processing equipment 59 (located on rig 50, on vessels 22, or at other suitable locations) and may be designed to control firing of the acoustic source signals so that the timing of an additional shot time (e.g. a shot time via slave vessel 57) is based on the initial shot time (e.g. a shot time via master vessel 56) plus a dither value.

The synchronization unit of, for example, surface processing equipment 59, may coordinate the firing of dithered acoustic signals with recording of acoustic signals by the downhole acquisition system 26. The processor system may be configured to separate a data stream of the initial shot and a data stream of the additional shot via a coherency filter. As discussed above, however, other implementations may employ pure simultaneous acquisition and/or may not use separation of the data streams. In such implementations, the dither is effectively zero.

After an initial shot time at T=0 (T0) is determined, subsequent firings of acoustic source arrays 24 may be offset by a dither. The dithers can be positive or negative and sometimes are created as pre-defined random delays. Use of dithers facilitates the separation of simultaneous or near-simultaneous data sets to simplify the data processing. The ability to have the acoustic source arrays 24 fire in simultaneous or near-simultaneous patterns may reduce the overall amount of time for three-dimensional vertical seismic profiling source acquisition. This, in turn, may significantly reduce rig time. As a result, the overall cost of the seismic operation may be reduced, rendering the data intensive process much more accessible.

If the acoustic source arrays used in the seismic data acquisition are widely separated, the difference in move-outs across the acoustic receiver array of the wave fields generated by the acoustic sources 24 can be used to obtain a clean data image via processing the data without further special considerations. However, even when the acoustic sources 24 are substantially co-located in time, data acquired by any of the methods involving dithering of the firing times of the individual sources 24 described herein can be processed to a formation image leaving hardly any artifacts in the final image. This is accomplished by taking advantage of the incoherence of the data generated by one acoustic source 24 when seen in the reference time of the other acoustic source 24.

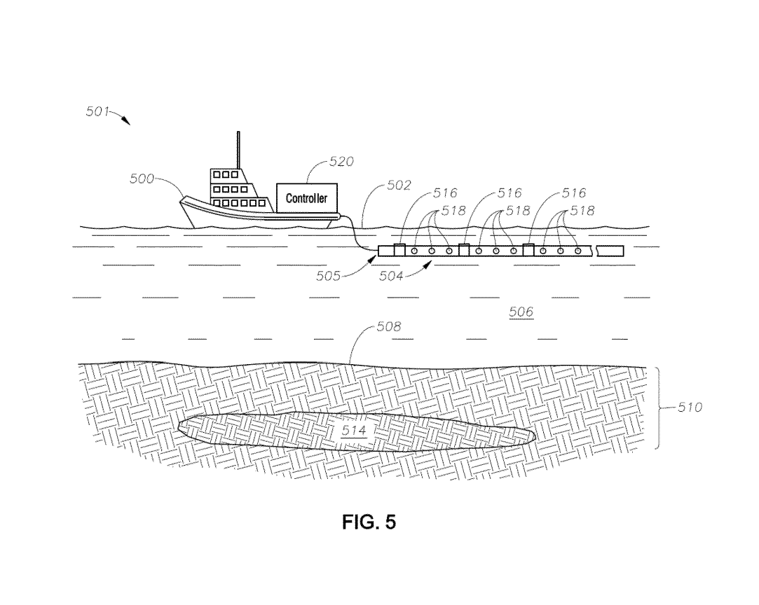

FIG. 5 illustrates a schematic diagram of a marine-based seismic acquisition system 501 for use in a seismic survey in accordance with implementations of various techniques described herein. In system 501, survey vessel 500 tows one or more seismic streamers 505 (one streamer 505 being depicted in FIG. 5) behind the vessel 500. In one implementation, streamers 505 may be arranged in a spread 504 in which multiple streamers 505 are towed in approximately the same plane at the same depth. Although various techniques are described herein with reference to a marine-based seismic acquisition system shown in FIG. 5, it should be understood that other marine-based seismic acquisition system configurations may also be used. For instance, the streamers 505 may be towed at multiple planes and/or multiple depths, such as in an over/under configuration. In one implementation, the streamers 505 may be towed in a slanted configuration, where fronts of the streamers are towed shallower than tail ends of the streamers.

Seismic streamers 505 may be several thousand meters long and may contain various support cables, as well as wiring and/or circuitry that may be used to facilitate communication along the streamers 505. In general, each streamer 505 may include a primary cable where seismic receivers that record seismic signals may be mounted. In one implementation, seismic receivers may include hydrophones that acquire pressure data. In another implementation, seismic receivers may include multi-component sensors such that each sensor is capable of detecting a pressure wavefield and at least one component of a particle motion that is associated with acoustic signals that are proximate to the sensor. Examples of particle motions include one or more components of a particle displacement, one or more components (i.e., inline (x), crossline (y) and vertical (z) components) of a particle velocity and one or more components of a particle acceleration.

Depending on the particular survey need, the multi-component seismic receiver may include one or more hydrophones, geophones, particle displacement sensors, particle velocity sensors, accelerometers, pressure gradient sensors, or combinations thereof. In one implementation, the multi-component seismic receiver may be implemented as a single device or may be implemented as a plurality of devices.

Marine-based seismic data acquisition system 501 may also include one or more seismic sources, such as air guns and the like. In one implementation, seismic sources may be coupled to, or towed by, the survey vessel 500. In another implementation, seismic sources may operate independently of the survey vessel 500 in that the sources may be coupled to other vessels or buoys.

As seismic streamers 505 are towed behind the survey vessel 500, acoustic signals, often referred to as “shots,” may be produced by the seismic sources and are directed down through a water column 506 into strata 510 beneath a water bottom surface 508. Acoustic signals may be reflected from the various subterranean geological formations, such as formation 514 depicted in FIG. 5. The incident acoustic signals that are generated by the sources may produce corresponding reflected acoustic signals, or pressure waves, which may be sensed by seismic sensors of the seismic streamers 505.

The seismic sensors may generate signals, called “traces,” which indicate the acquired measurements of the pressure wavefield and particle motion. The traces (i.e., seismic data) may be recorded and may be processed by a signal processing unit or a controller 520 deployed on the survey vessel 500.

The goal of the seismic acquisition may be to build up an image of a survey area for purposes of identifying subterranean geological formations, such as the geological formation 514. Subsequent analysis of the image may reveal probable locations of hydrocarbon deposits in subterranean geological formations. In one implementation, portions of the analysis of the image may be performed on the seismic survey vessel 500, such as by the controller 520.

A particular seismic source may be part of an array of seismic source elements (such as air guns, for example) that may be arranged in strings (gun strings, for example) of the array. Regardless of the particular composition of the seismic sources, the sources may be fired in a particular time sequence during the survey. Although FIG. 5 illustrates a marine-based seismic acquisition system, the marine-based seismic acquisition system is merely provided as an example of a seismic acquisition system that may be used with the methods described herein. It should be noted that the methods described herein may also be performed on a seabed-based seismic acquisition system, or a transition zone-based seismic acquisition system.

In addition to the seismic sources and receivers, an acoustic positioning system may be used to determine the positions of seismic acquisition equipment used in the seismic acquisition system 501, such as the seismic streamers 505 and the seismic receivers disposed thereon. The acoustic positioning system may include one or more acoustic positioning sources 516 and one or more acoustic positioning receivers 518. In one implementation, the acoustic positioning sources 516 and the acoustic positioning receivers 518 may be disposed along the one or more seismic streamers 505. In such an implementation, and as described further below, power and/or control electronics may be incorporated into the one or more seismic streamers 505 as well. In a further implementation, the acoustic positioning system may be a stand-alone system with separate power supply and communication telemetry links to the survey vessel 500.

In one implementation, the acoustic positioning receivers 518 may be the same as the seismic receivers described above or some subset of the seismic receivers. The acoustic positioning sources 516 may be higher frequency acoustic sources, as opposed to the seismic sources described above that may be used for performing a seismic survey operation and may be of a lower frequency. The acoustic positioning sources 516 may include an acoustic transmitter or any other implementation known to those skilled in the art. In some implementations, the acoustic positioning source 516 and the acoustic positioning receiver may be combined into a single physical unit. In some implementations, an acoustic positioning source 516 and an acoustic positioning receiver 518 may be combined into one transducer unit. In such an implementation, the transducer unit may act as an acoustic positioning source 516, an acoustic positioning acoustic positioning receiver 518, or both.

The controller 520 may be configured to control activation of the acoustic positioning sources 516 of the acoustic positioning system. In particular, and as further discussed below with respect to the operation of the acoustic positioning system, the acoustic positioning sources 516 may produce one or more acoustic positioning signals that may be recorded by the acoustic positioning receivers 518. In one implementation, an acoustic positioning receiver 518 may detect acoustic positioning signals from an acoustic positioning source 516 located within the same seismic streamer 505 as the acoustic positioning receiver 518. In another implementation, an acoustic positioning receiver 518 may detect acoustic positioning signals from an acoustic positioning source 516 located within a different seismic streamer 505 as the acoustic positioning receiver 518.

As also discussed below with respect to the operation of the acoustic positioning system, the controller 520 may be configured to process the acoustic positioning signals collected by the acoustic positioning receivers 518. In particular, processing an acquired acoustic positioning signal may yield the travel time of the signal between an acoustic positioning source 516 and an acoustic positioning receiver 518. In turn, the travel time may be used to derive the travel distance of the acoustic positioning signal between the acoustic positioning source 516 and the acoustic positioning receiver 518. This travel distance can then be used to calculate the relative positions of the acoustic positioning source 516 and/or the acoustic positioning receiver 518 in the seismic streamer 505. A distance between relative positions of an acoustic positioning source 516 and an acoustic positioning receiver 518 may be referred to as a range.

In one implementation, the controller 520 may process the relative positions and other information to produce (or update) a positioning model to enable estimation of positioning of the seismic acquisition equipment (e.g., position of a seismic streamer 505, depth of a seismic streamer 505, distances between seismic receivers, etc.).

Attention is now directed to methods, techniques, and workflows for processing and/or transforming collected data that are in accordance with some implementations. Some operations in the processing procedures, methods, techniques, and workflows disclosed herein may be combined and/or the order of some operations may be changed. In the geosciences and/or other multi-dimensional data processing disciplines, various interpretations, sets of assumptions, and/or domain models such as velocity models, may be refined in an iterative fashion; this concept may be applicable to the procedures, methods, techniques, and workflows as discussed herein. This iterative refinement can include use of feedback loops executed on an algorithmic basis, such as via a computing system, as discussed later, and/or through manual control by a user who may make determinations regarding whether a given action, template, or model has become accurate.

### Acquisition Footprint Attenuation

As noted above, various forms of seismic surveys (e.g., marine, land, seabed, etc.) may be used to acquire seismic data related to a region of interest. In one implementation, the seismic data may be three-dimensional (3D), and may be organized in the form of a seismic volume corresponding to the region of interest, such as in the form of a 3D seismic cube. Such a seismic volume may be used to provide more detailed structural and stratigraphic images of subterranean geological formations.

The 3D seismic cube may be a gather of seismic traces, where each seismic trace is a time-dependent amplitude signal and is associated with a given position over which the acquisition has been carried out. In one such implementation, the 3D seismic cube may be organized in a time domain. In particular, in the 3D seismic cube, the seismic data may be organized with respect to an inline direction (x), a crossline direction (y), and time (t), where time may be a vertical axis of the cube. The time domain may also be hereinafter referred to as the XYT domain. As known to those in the art, if a horizontal plane were to pass through seismic data in the cube, that plane may be called a time slice. As is also known, the corresponding seismic data on that time slice may have the same reflection time.

As mentioned above, one or more acquisition footprints may be present in a 3D seismic cube, and these acquisition footprints may interfere with the interpretation of the stratigraphic images of the seismic cube. The acquisition footprints may be undesired amplitude and or phase deviations in the seismic data, where the footprints may take the form of linear spatial grid patterns (hereinafter referred to as amplitude stripes) that appear in time slices or horizon slices produced from the 3D seismic cube. The amplitude stripes may be either horizontal or vertical. The shallower time slices may be more susceptible to the presence of acquisition footprints.

The acquisition footprints may be produced for various reasons. In many scenarios, the acquisition footprints tend to mirror the acquisition geometry used during the seismic survey. In particular, the acquisition footprints may be an expression of the surface that has left an imprint on the stack of the 3D seismic cube. In some scenarios, improper seismic data processing may lead to acquisition footprints. In particular, the presence of the acquisition footprints may be due to:, variation in the offset and azimuth distribution from bin to bin in the acquisition geometry; uniformity in the inline direction and irregularity in the cross-line direction in the acquisition geometry; deviation from a regular geometry pattern; streamer feathering in marine seismic surveys; and/or other reasons known to those skilled in the art.

As also noted above, these acquisition footprints may interfere with the interpretation of the seismic cube, as the footprints may mask the actual amplitude anomalies in the seismic cube under consideration for stratigraphic interpretation, analysis, and/or reservoir attribute studies. For example, an acquisition footprint may mask the presence of a channel in a shallow time slice of the seismic cube.

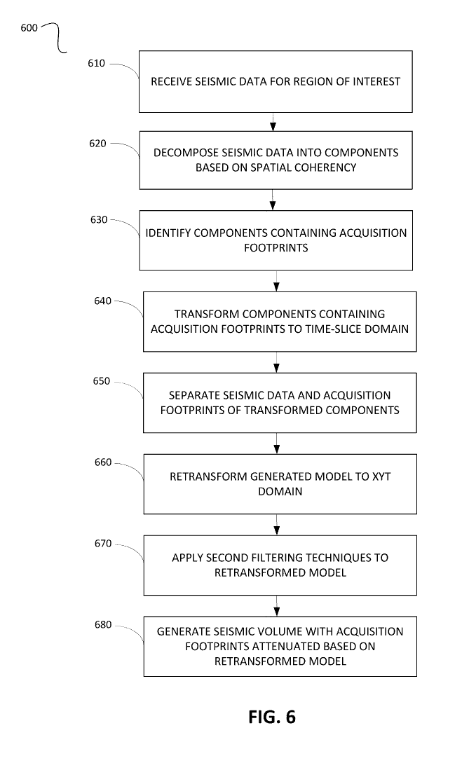

As such, one or more implementations described herein may be used to attenuate the presence of one or more acquisition footprints in seismic data. For example, FIG. 6 illustrates a flow diagram of a method 600 for determining a fracture type of one or more fractures in a region of interest in accordance with implementations of various techniques described herein. In one implementation, method 600 may be performed by a computer application. It should be understood that while method 600 indicates a particular order of execution of operations, in some implementations, certain portions of the operations might be executed in a different order. Further, in some implementations, additional operations or blocks may be added to the method. Likewise, some operations or blocks may be omitted.

At block 610, seismic data for a region of interest may be received. The region of interest may include one or more subterranean formations or other areas of a subsurface of the earth that may be of particular interest. For example, the region of interest may include one or more geological formations, reservoirs, and/or the like that may possibly contain hydrocarbons. The subsurface formations of the region of interest may include one or more discontinuities, such as one or more fractures, one or more faults, one or more bedding planes, one or more planes of weakness, and/or the like.

The seismic data may be obtained and/or received using any implementation known to those skilled in the art, such as the one or more implementations discussed above with respect to FIGS. 1.1-5. As mentioned above, in one implementation, the seismic data may be three-dimensional (3D), and may be organized in the form of a seismic volume corresponding to the region of interest, such as in the form of a 3D seismic cube. In a further implementation, the 3D seismic cube may be organized in the XYT domain. In another implementation, the seismic data received may be post-stack migrated data.

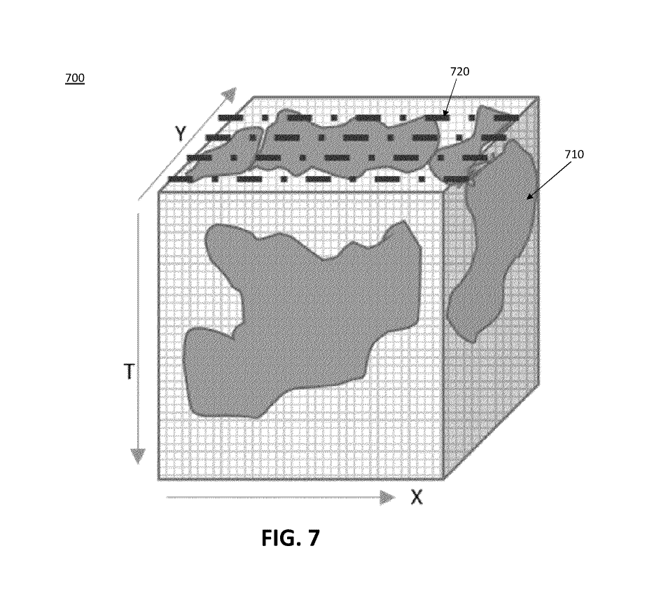

For example, FIG. 7 illustrates a diagram of a 3D seismic cube 700 for the region of interest in accordance with implementations of various techniques described herein. In particular, the seismic cube 700 may be organized in the XYT domain, such that seismic data is organized with respect to an inline direction (x), a crossline direction (y), and time (t), where time is a vertical axis of the cube 700. The cube 700 may also include seismic data 710 that is representative of one or more subterranean formations, and may also include acquisition footprints 720 in the form of amplitude stripes appearing in time slices of the cube 700.

At block 620, the received seismic data may be decomposed into a plurality of components based on spatial coherency. In one such implementation, a 3D seismic cube organized in the XYT domain may be decomposed into a plurality of components based on spatial coherency. In particular, the components generated from the decomposition may range from a high spatial coherency to a low spatial coherency. Spatial coherency may refer to a correlation or predictable relationship between waveforms at one or more points in space. Any decomposition technique known to those in the art may be used to generate such components based on spatial coherency.

The one or more acquisition footprints in the seismic cube may have a relatively consistent range of spatial coherency. As such, decomposing the seismic cube may isolate or approximately isolate the acquisition footprints into a subset of the generated components.

In a further implementation, the decomposition technique used to decompose the seismic cube into the plurality of components may be a principal component analysis (PCA). In particular, as known to those in the art, PCA may use a correlation-based filtering method to decompose the seismic cube into a set of values of linearly uncorrelated variables called principal components, where data within each principal component is orthogonal to other data within the principal component. The principal components generated from the decomposition may range from a high spatial coherency to a low spatial coherency. Any PCA technique known to those in the art may be used, including the Karhunen-Loeve Transform (KLT) technique.

In one such implementation, PCA may be used to decompose the seismic cube into principal components based on an autocorrelation function, where each principal component may be a cube, and a sum of values of the principal components may be approximately equal to values of the seismic cube.

In yet another implementation, the seismic cube may be decomposed into the plurality of components based on a temporal coherency, as well as spatial coherency. Temporal coherency may refer to a correlation or predictable relationship between waveforms at one or more points in time. In another implementation, block 620 may be repeated for multiple iterations, depending on the complexity and the geometric pattern of the acquisition footprints.

At block 630, the one or more of the components containing the acquisition footprints may be identified. In particular, of those components generated at block 620, those components which contain the acquisition footprints may be identified and then summed together. These summed components may be organized as a cube corresponding to the acquisition footprints, with the cube organized in the XYT domain.

The components containing the acquisition footprints may be identified in various ways, e.g., a visual inspection of the components generated at block 620. Through the visual inspection, an evaluation of the spatial coherency of these components may be performed such that the one or more of the components containing the acquisition footprints may be identified. In one implementation, one or more quality control (QC) processes may be used to examine the spatial coherency of the components, such that the one or more of the components containing the acquisition footprints may be identified. For example, the QC processes may include using one or more variograms to identify the one or more of the components containing the acquisition footprints. A variogram may be a geostatistical tool used to depict spatial variance within groups of data, plotted as a function of distance between data points. The variograms may be used to map spatial and vertical variability for the components generated at block 620.

As noted above, once the one or more of the components containing the acquisition footprints have been identified, these components may be summed and organized as a cube corresponding to the acquisition footprints. It should be noted that the decomposition of block 620 may not fully isolate the acquisition footprints from the seismic data among the generated components. As such, the components containing the acquisition footprints may also contain a portion of the seismic data received at block 610.

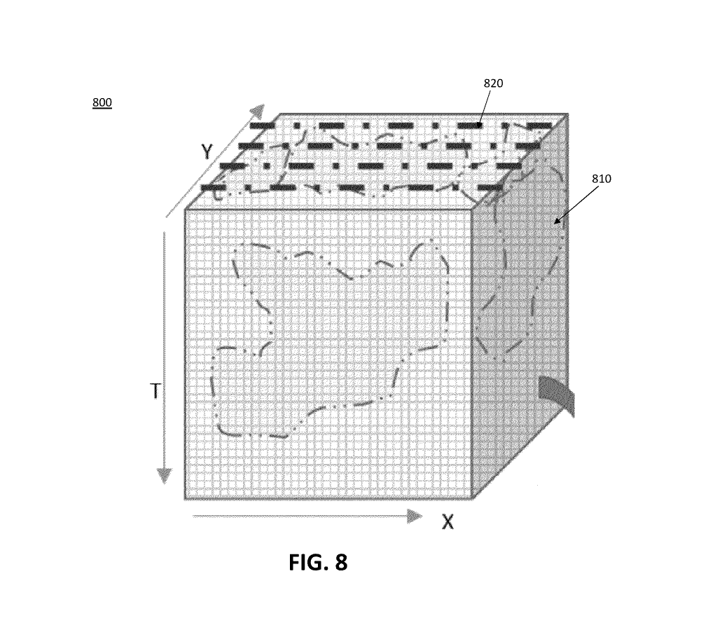

For example, FIG. 8 illustrates a diagram of a 3D cube 800, where the cube 800 is formed from the summed components which correspond to the acquisition footprints in accordance with implementations of various techniques described herein. In particular, the cube 800 may be organized in the XYT domain in a similar manner as the cube 700. The cube 800 may include acquisition footprints 820 in the form of amplitude stripes appearing in time slices of the cube 800. The cube 800 may also include a subset 810 of the seismic data that was received at block 610, where the subset 810 is representative of one or more subterranean formations.

Further, having identified the components containing the acquisition footprints, those remaining components at block 620 which do not contain the acquisition footprints may be leftover. In one implementation, these remaining components may contain a majority of the seismic data received at block 610. In another implementation, those remaining components which do not contain the acquisition footprints may also be identified using the methods discussed above, such as visual inspection and/or QC processes.

At block 640, the one or more of the components containing the acquisition footprints may be transformed to a time-slice domain. In one implementation, the cube corresponding to the acquisition footprints, formed by summing components as described at block 630, may be transformed to the time-slice domain from the XYT domain.

In transforming the cube corresponding to the acquisition footprints to the time-slice domain, the cube may be transformed into a series of single sample time slices. In such an implementation, the series of single sample time slices may be represented as a transformed cube. In particular, the data corresponding to the acquisition footprints may be reorganized with respect to an inline direction (x), a crossline direction (y), and time (t), where either the inline or the crossline direction may be used as a vertical axis. Where the inline direction is used as the vertical axis, the time-slice domain may also be referred to as the TYX domain. Similarly, where the crossline direction is used as the vertical axis, the time-slice domain may also be referred to as the TXY domain.

Transforming the cube corresponding to the acquisition footprints to the time-slice domain in such a manner may be viewed as a data rearrangement, whereby the cube is rotated so that either the inline or the crossline direction is used as a vertical axis.

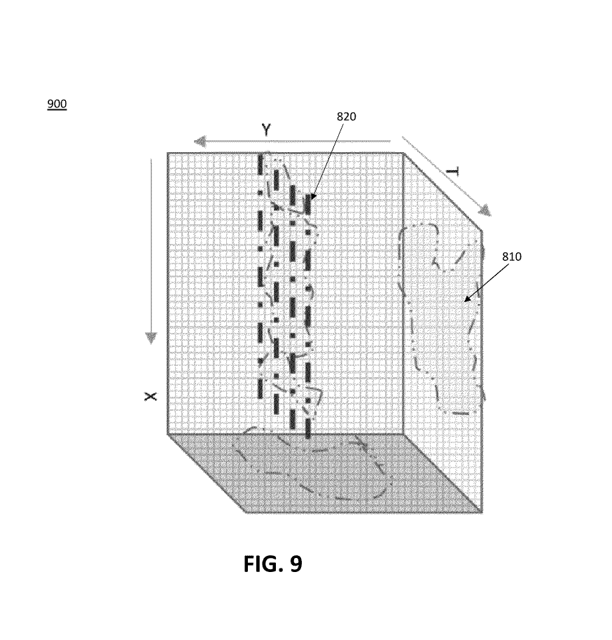

For example, FIG. 9 illustrates a diagram of a transformed 3D cube 900 in accordance with implementations of various techniques described herein. The cube 900 may have been obtained by transforming the cube 800 of FIG. 8 to the time-slice domain. In particular, to transform the cube 800 to the transformed cube 900, the cube 800 may have been rotated such that the inline direction is used as the vertical axis. As such, the cube 900 may be in the TYX domain. As shown, the transformed cube 900 still includes a subset 810 of the seismic data that was received at block 610 and acquisition footprints 820 in the form of amplitude stripes, though translated to the time-slice domain.

In transforming the cube corresponding to the acquisition footprints to the time-slice domain, the seismic data and the acquisition footprints contained therein may be translated into an ultra-low frequency component. In such an implementation, the translated seismic data and/or the translated acquisition footprints may appear as repeatable patterns or may appear scattered.

At block 650, the seismic data and the acquisition footprints of the transformed components may be separated. As noted above, the components containing the acquisition footprints may be transformed into a transformed cube in the time-slice domain. The transformed cube may contain both seismic data and acquisition footprints. In one implementation, one or more first filtering techniques may be applied to the transformed cube in order to separate the seismic data and the acquisition footprints contained therein. In applying the one or more first filtering techniques, the transformed cube may be separated such that a model of seismic data and/or a model of acquisition footprints may be generated. Each model may be organized as a cube, and, further, each may also be organized in the time-slice domain.

In one implementation, the seismic data and the acquisition footprints of the transformed cube may be separated by filtering the acquisition footprints from the transformed cube. In such an implementation, a model of seismic data may be generated, where the model may be in the form of a transformed seismic cube in the time-slice domain.

In such an implementation, instead of filtering the seismic data, the acquisition footprints may be filtered from the transformed cube if the seismic data is determined to have a greater spatial and/or temporal coherency than the acquisition footprints. Such a determination may be made using any technique known to those in the art, including visual inspection.

In another implementation, the seismic data and the acquisition footprints of the transformed cube may be separated by enhancing the acquisition footprints and filtering the seismic data from the transformed cube. In such an implementation, a model of acquisition footprints may be generated, where the model may be in the form of a transformed acquisition footprints cube in the time-slice domain.

In such an implementation, instead of filtering the acquisition footprints, the seismic may be filtered from the transformed cube if the acquisition footprints are determined to have a greater spatial and/or temporal coherency than the seismic data. Such a determination may be made using any technique known to those in the art, including visual inspection.

The one or more first filtering techniques used to perform the filtering discussed above may include any filtering technique known to those in the art, including a median filter, a kriging filter, a bandpass filter, and/or a narrow band filter. The particular filtering technique applied to the transformed cube may depend upon the spatial and/or temporal coherency of the seismic data or acquisition footprints being filtered. In a further implementation, one or more inline and/or crossline smoothing operators, as known to those in the art, may be used to further attenuate the seismic data or acquisition footprints in the transformed cube.

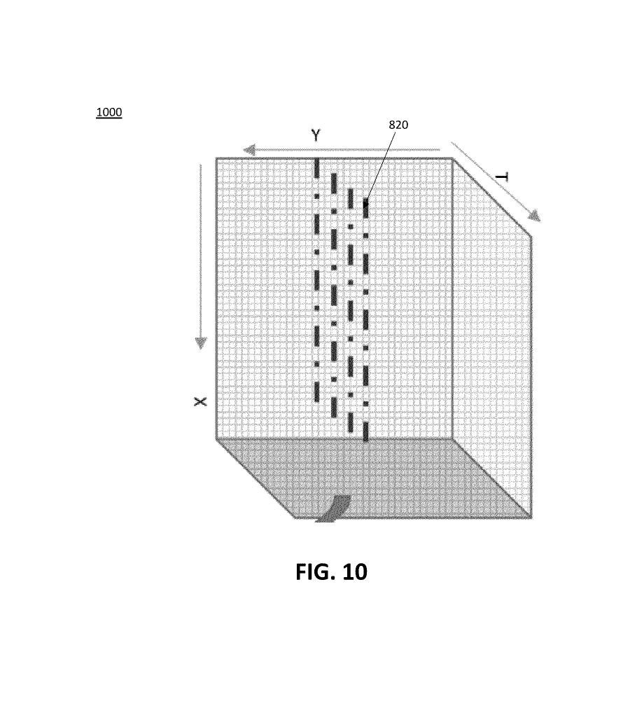

FIG. 10 illustrates a diagram of a transformed 3D cube 1000 after one or more first filtering techniques have been applied in accordance with implementations of various techniques described herein. As shown, the one or more first filtering techniques may have removed the subset 810 of the seismic data that was present in transformed cube 900. As such, the cube 1000 becomes a transformed acquisition footprints cube in the time-slice domain, as the cube 100 still includes the acquisition footprints 820 in the form of amplitude stripes.

At block 660, either the model of seismic data or the model of acquisition footprints generated at block 650 may be transformed to the XYT domain. In particular, as noted above, the model of seismic data or the model of acquisition footprints generated at block 650 may both be transformed cubes in the time-slice domain. Thus, at block 660, either a transformed acquisition footprints cube in the time-slice domain or a transformed seismic cube in the time-slice domain may be retransformed back to the XYT domain.

In one implementation, retransforming the transformed acquisition footprints cube from block 650 to the XYT domain may be performed by rotating the cube, such that time may be a vertical axis of the retransformed cube. This retransformed cube may be referred to as a retransformed acquisition footprints cube in the XYT domain. Similarly, retransforming the transformed seismic cube from block 650 to the XYT domain may be performed by rotating the cube, such that time may be a vertical axis of the retransformed cube. This retransformed cube may be referred to as a retransformed seismic cube in the XYT domain.

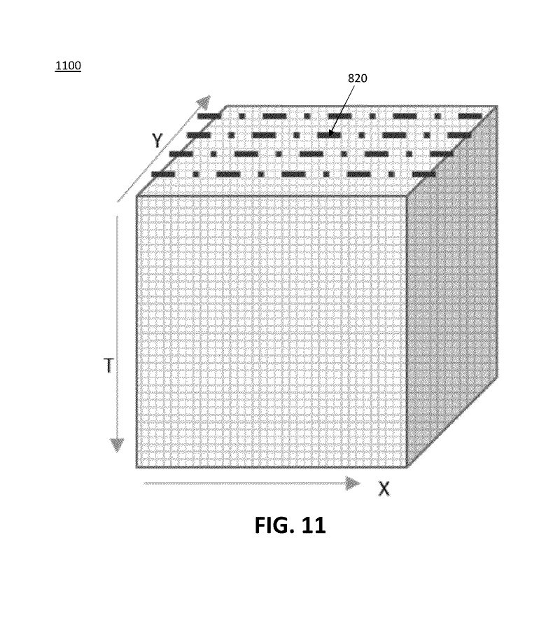

FIG. 11 illustrates a diagram of a retransformed 3D cube 1100 in accordance with implementations of various techniques described herein. The cube 1100 may have been obtained by retransforming the transformed acquisition footprints cube 1000 of FIG. 10 to the XYT domain. In particular, to transform the transformed acquisition footprints cube 1000 to the retransformed cube 1100, the cube 1000 may have been rotated such that time is used as the vertical axis. As such, the transformed acquisition footprints cube 1000 becomes a retransformed acquisition footprints cube 1100 in the XYT domain, as the cube 1100 still includes the acquisition footprints 820 in the form of amplitude stripes.

At block 670, one or more second filtering techniques may be applied to the retransformed cube from block 660 in order to further filter out any residual seismic data or residual acquisition footprints contained therein. In particular, the second filtering techniques may be used to filter out any residual seismic data from the retransformed acquisition footprints cube. In addition, the second filtering techniques may be used to filter out any residual acquisition footprints data from the retransformed seismic cube.

The one or more second filtering techniques used to perform the filtering discussed above may include any filtering technique known to those in the art, including a median filter, a kriging filter, a bandpass filter, and/or a narrow band filter. The particular filtering technique applied to the retransformed cube may depend upon the spatial and/or temporal coherency of the seismic data or acquisition footprints being filtered. In a further implementation, one or more inline and/or crossline smoothing operators, as known to those in the art, may be used to further attenuate the seismic data or acquisition footprints in the retransformed cube.

At block 680, a seismic volume corresponding to the region of interest with acquisition footprints attenuated may be generated based on the retransformed cube from block 670. In one implementation, the seismic volume may be a 3D seismic cube organized in the XYT domain with acquisition footprints attenuated.

As noted above, the retransformed cube from block 670 may be a retransformed seismic cube in the XYT domain or retransformed acquisition footprints cube in the XYT domain. In one implementation, if the retransformed cube from block 670 is a retransformed seismic cube, then this retransformed seismic cube may be combined with the remaining components of received seismic data which do not contain acquisition footprints (see block 630). This combination may be used to form a seismic cube with acquisition footprints attenuated that is organized in the XYT domain. In another implementation, if the retransformed cube from block 670 is a retransformed acquisition footprints cube, then the retransformed acquisition footprints cube may be subtracted from the received seismic data at block 610. This subtraction may be used to form a seismic cube with acquisition footprints attenuated that is organized in the XYT domain.

In a further implementation, if the acquisition footprints are sufficiently attenuated in the seismic cube produced at block 680, then the method 600 may stop. For example, method 600 may stop if the amount of acquisition footprints in the seismic cube is less than a predetermined amount.

In a further implementation, if the acquisition footprints are not sufficiently attenuated in the seismic cube produced at block 680, then this seismic cube may be used as an input to block 620, and blocks 620-680 may be repeated. For example, blocks 620-680 may be repeated if the amount of acquisition footprints is greater than a predetermined amount. In such an implementation, blocks 620-680 may be repeated for any number of iterations until the acquisition footprints are sufficiently attenuated and/or signal leakage is minimized in the seismic cube generated at block 680. In a further implementation, one or more subsequent iterations of blocks 620-680 may be performed in a different order or manner than previous iterations. For example, in subsequent iterations, the decomposition of block 620 may be performed after the transformation of block 640 and the filtering of block 650. In another example, one or more subsequent iterations of block 650 may perform different first filtering techniques than was used in previous iterations. The number of iterations performed and the particular order of operation for blocks 620-680 performed may depend on the complexity of acquisition grid, acquisition footprints, spatial coherency, or any other factor known to those in the art.

In sum, the implementations for acquisition footprint attenuation in seismic data, as described above with respect to FIGS. 1.1-11, may assist with stratigraphic interpretation, analysis, and/or reservoir attribute studies, particularly in shallower depths of a region of interest. In particular, the implementations described above may be used to attenuate the presence of one or more acquisition footprints in seismic volumes. Such attenuation may be used to improve the clarity and confidence in reservoir and land models (i.e., seismic volumes), such that the improved models may be used to better interpret and/or identify objects in a region of interest. In particular, without the acquisition footprints masking objects in the models, these objects may become more noticeable to an interpreter. For example, such objects may include shallow channels in marine environments, shallow gas, cavities in the region of interest, the presence of hydrocarbons in the region of interest, and/or the like. Additionally, such attenuation may be used to increase the accuracy of fracture model and for permeability estimate of a vertical well.

Further, the implementations described above may be used to attenuate acquisition footprints for a variety of acquisition geometries. In addition, the use of subsequent iterations in the methods of the implementations described above may be used for changing conditions and/or acquisition geometries.

### Computing Systems

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, smart watches, personal wearable computing systems networked with other computing systems, tablet computers, and distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. While program modules may execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. The distributed computing environments may span multiple continents and multiple vessels, ships or boats. In a distributed computing environment, program modules may be located in both local and remote computer storage media including memory storage devices.

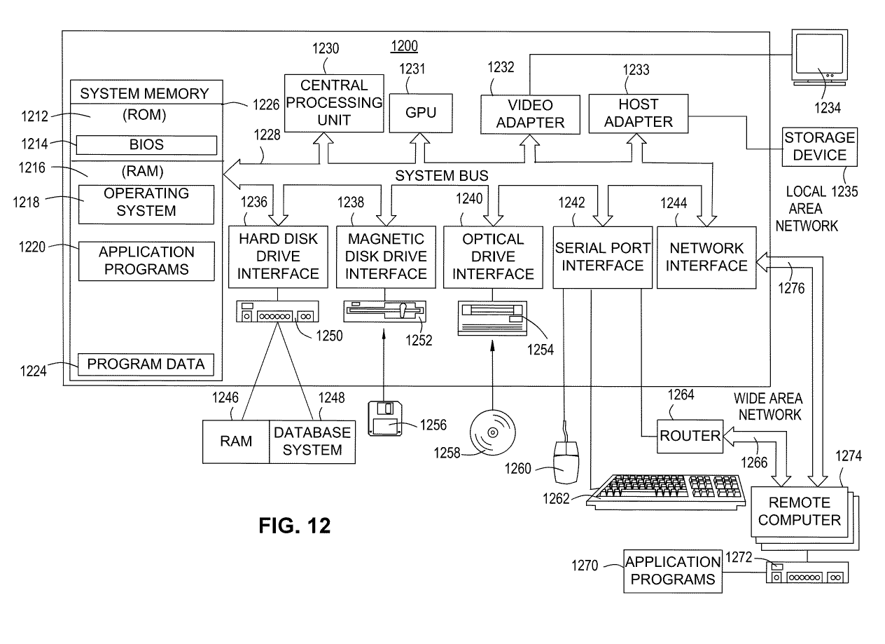

FIG. 12 illustrates a schematic diagram of a computing system 1200 in which the various technologies described herein may be incorporated and practiced. Although the computing system 1200 may be a conventional desktop or a server computer, as described above, other computer system configurations may be used.

The computing system 1200 may include a central processing unit (CPU) 1230, a system memory 1226, a graphics processing unit (GPU) 1231 and a system bus 1228 that couples various system components including the system memory 1226 to the CPU 1230. Although one CPU is illustrated in FIG. 12, it should be understood that in some implementations the computing system 1200 may include more than one CPU. The GPU 1231 may be a microprocessor specifically designed to manipulate and implement computer graphics. The CPU 1230 may offload work to the GPU 1231. The GPU 1231 may have its own graphics memory, and/or may have access to a portion of the system memory 1226. As with the CPU 1230, the GPU 1231 may include one or more processing units, and the processing units may include one or more cores. The system bus 1228 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 1226 may include a read-only memory (ROM) 1212 and a random access memory (RAM) 1246. A basic input/output system (BIOS) 1214, containing the basic routines that help transfer information between elements within the computing system 1200, such as during start-up, may be stored in the ROM 1212.

The computing system 1200 may further include a hard disk drive 1250 for reading from and writing to a hard disk, a magnetic disk drive 1252 for reading from and writing to a removable magnetic disk 1256, and an optical disk drive 1254 for reading from and writing to a removable optical disk 1258, such as a CD ROM or other optical media. The hard disk drive 1250, the magnetic disk drive 1252, and the optical disk drive 1254 may be connected to the system bus 1228 by a hard disk drive interface 1256, a magnetic disk drive interface 1258, and an optical drive interface 1250, respectively. The drives and their associated computer-readable media may provide nonvolatile storage of computer-readable instructions, data structures, program modules and other data for the computing system 1200.

Although the computing system 1200 is described herein as having a hard disk, a removable magnetic disk 1256 and a removable optical disk 1258, it should be appreciated by those skilled in the art that the computing system 1200 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 1200. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 1200 may also include a host adapter 1233 that connects to a storage device 1235 via a small computer system interface (SCSI) bus, a Fiber Channel bus, an eSATA bus, or using any other applicable computer bus interface. Combinations of any of the above may also be included within the scope of computer readable media.

A number of program modules may be stored on the hard disk 1250, magnetic disk 1256, optical disk 1258, ROM 1212 or RAM 1216, including an operating system 1218, one or more application programs 1220, program data 1224, and a database system 1248. The application programs 1220 may include various mobile applications (“apps”) and other applications configured to perform various methods and techniques described herein. The operating system 1218 may be any suitable operating system that may control the operation of a networked personal or server computer, such as Windows® XP, Mac OS® X, Unix-variants (e.g., Linux® and BSD®), and the like.

A user may enter commands and information into the computing system 1200 through input devices such as a keyboard 1262 and pointing device 1260. Other input devices may include a microphone, joystick, game pad, satellite dish, scanner, or the like. These and other input devices may be connected to the CPU 1230 through a serial port interface 1242 coupled to system bus 1228, but may be connected by other interfaces, such as a parallel port, game port or a universal serial bus (USB). A monitor 1234 or other type of display device may also be connected to system bus 1228 via an interface, such as a video adapter 1232. In addition to the monitor 1234, the computing system 1200 may further include other peripheral output devices such as speakers and printers.

Further, the computing system 1200 may operate in a networked environment using logical connections to one or more remote computers 1274. The logical connections may be any connection that is commonplace in offices, enterprise-wide computer networks, intranets, and the Internet, such as local area network (LAN) 1256 and a wide area network (WAN) 1266. The remote computers 1274 may be another a computer, a server computer, a router, a network PC, a peer device or other common network node, and may include many of the elements describes above relative to the computing system 1200. The remote computers 1274 may also each include application programs 1270 similar to that of the computer action function.

When using a LAN networking environment, the computing system 1200 may be connected to the local network 1276 through a network interface or adapter 1244. When used in a WAN networking environment, the computing system 1200 may include a router 1264, wireless router or other means for establishing communication over a wide area network 1266, such as the Internet. The router 1264, which may be internal or external, may be connected to the system bus 1228 via the serial port interface 1252. In a networked environment, program modules depicted relative to the computing system 1200, or portions thereof, may be stored in a remote memory storage device 1272. It will be appreciated that the network connections shown are merely examples and other means of establishing a communications link between the computers may be used.

The network interface 1244 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 1274.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Also, the program code may execute entirely on a user's computing device, on the user's computing device, as a stand-alone software package, on the user's computer and on a remote computer or entirely on the remote computer or a server computer.

The system computer 1200 may be located at a data center remote from the survey region. The system computer 1200 may be in communication with the receivers (either directly or via a recording unit, not shown), to receive signals indicative of the reflected seismic energy. These signals, after conventional formatting and other initial processing, may be stored by the system computer 1200 as digital data in the disk storage for subsequent retrieval and processing in the manner described above. In one implementation, these signals and data may be sent to the system computer 1200 directly from sensors, such as geophones, hydrophones and the like. When receiving data directly from the sensors, the system computer 1200 may be described as part of an in-field data processing system. In another implementation, the system computer 1200 may process seismic data already stored in the disk storage. When processing data stored in the disk storage, the system computer 1200 may be described as part of a remote data processing center, separate from data acquisition. The system computer 1200 may be configured to process data as part of the in-field data processing system, the remote data processing system or a combination thereof.

Those with skill in the art will appreciate that any of the listed architectures, features or standards discussed above with respect to the example computing system 1200 may be omitted for use with a computing system used in accordance with the various embodiments disclosed herein because technology and standards continue to evolve over time.

Of course, many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a three-dimensional space and/or subsurface region of interest may be collected and processed, e.g., medical imaging techniques such as tomography, ultrasound, MRI and the like for human tissue; radar, sonar, and LIDAR imaging techniques; and other appropriate three-dimensional imaging problems.

While the foregoing is directed to implementations of various technologies described herein, other and further implementations may be devised without departing from the basic scope thereof. Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

What is claimed is:

1. A method, comprising:
receiving seismic data that had been acquired using a seismic survey of a region of interest;
decomposing the received seismic data into a plurality of components based on a spatial coherency of the plurality of components;
identifying one or more components of the plurality of components having one or more acquisition footprints;
transforming the one or more components having the one or more acquisition footprints to a time-slice domain;
separating the one or more acquisition footprints from the seismic data within the one or more transformed components; and
generating a seismic volume corresponding to the region of interest, wherein the one or more acquisition footprints within the seismic volume are attenuated based on the separation.

2. The method of claim 1, wherein decomposing the received seismic data comprises decomposing the received seismic data based on the spatial coherency using a principal component analysis, wherein the plurality of components comprises a plurality of principal components.

3. The method of claim 1, wherein identifying the one or more components of the plurality of components having the one or more acquisition footprints comprises identifying the one or more components based on a quality control process evaluating the spatial coherency of the plurality of components.

4. The method of claim 3, wherein transforming the one or more components comprises:
summing the one or more components of the plurality of components having the one or more acquisition footprints; and
transforming the summed components to the time-slice domain.

5. The method of claim 1, wherein transforming the one or more components having the one or more acquisition footprints to the time-slice domain comprises reorganizing the one or more components with respect to an inline direction, a crossline direction, and time, wherein the inline direction is used as a vertical axis.

6. The method of claim 1, wherein transforming the one or more components having the one or more acquisition footprints to the time-slice domain comprises reorganizing the one or more components with respect to an inline direction, a crossline direction, and time, wherein the crossline direction is used as a vertical axis.

7. The method of claim 1, wherein separating the one or more acquisition footprints from the seismic data within the transformed components comprises:
filtering the one or more acquisition footprints from the one or more transformed components; and
generating a model of seismic data based on the one or more filtered transformed components.

8. The method of claim 7, wherein filtering the one or more acquisition footprints comprises filtering the one or more acquisition footprints from the one or more transformed components using a median filter, a kriging filter, a bandpass filter, a narrow band filter, or combinations thereof.

9. The method of claim 7, comprising:
transforming the model of seismic data to a time domain; and
filtering residual acquisition footprints from the transformed model of seismic data.

10. The method of claim 9, wherein generating the seismic volume corresponding to the region of interest comprises combining the transformed model of seismic data with one or more components of the plurality of components without acquisition footprints.

11. The method of claim 1, wherein separating the one or more acquisition footprints from the seismic data within the transformed components comprises:
filtering the seismic data from the one or more transformed components; and
generating a model of acquisition footprints based on the one or more filtered transformed components.

12. The method of claim 11, comprising:
transforming the model of acquisition footprints to a time domain; and
filtering residual seismic data from the transformed model of acquisition footprints.

13. The method of claim 12, wherein generating the seismic volume corresponding to the region of interest comprises subtracting the transformed model of acquisition footprints from the received seismic data.

14. The method of claim 1, further comprising iteratively generating seismic volume corresponding to the region of interest until the one or more acquisition footprints within the seismic volume is less than a predetermined amount.

15. The method of claim 1, wherein the received seismic data is in the form of a three-dimensional seismic cube in a time domain.

16. The method of claim 1, wherein one or more acquisition footprints comprise one or more amplitude stripes.

17. A non-transitory computer-readable medium having stored thereon a plurality of computer-executable instructions which, when executed by a computer, cause the computer to:
receive seismic data acquired using a seismic survey of a region of interest;
decompose the received seismic data into a plurality of components based on a spatial coherency of the plurality of components;
identify one or more components of the plurality of components having one or more acquisition footprints;
transform the one or more components having the one or more acquisition footprints to a time-slice domain;
separate the one or more acquisition footprints from the seismic data within the one or more transformed components; and
generate a seismic volume corresponding to the region of interest, wherein the one or more acquisition footprints within the seismic volume are attenuated based on the separation.

18. The non-transitory computer-readable medium of claim 17, wherein the computer-executable instructions which, when executed by a computer, cause the computer to decompose the received seismic data, further comprise computer-executable instructions which, when executed by the computer, cause the computer to:
decompose the received seismic data based on the spatial coherency using a principal component analysis, wherein the plurality of components comprises a plurality of principal components.

19. A computer system, comprising:
a processor; and
a memory comprising a plurality of program instructions which, when executed by the processor, cause the processor to:
receive seismic data acquired using a seismic survey of a region of interest;
decompose the received seismic data into a plurality of components based on a spatial coherency of the plurality of components;
identify one or more components of the plurality of components having one or more acquisition footprints;
transform the one or more components having the one or more acquisition footprints to a time-slice domain;
separate the one or more acquisition footprints from the seismic data within the one or more transformed components; and
generate a seismic volume corresponding to the region of interest, wherein the one or more acquisition footprints within the seismic volume are attenuated based on the separation.

20. The computer system of claim 19, wherein the program instructions which, when executed by the processor, cause the processor to transform the one or more components having the one or more acquisition footprints to the time-slice domain, further comprise program instructions which, when executed by the processor, cause the processor to:
reorganize the one or more components with respect to an inline direction, a crossline direction, and time, wherein the inline direction is used as a vertical axis.
